(19) United States
(12) Patent Application Publication
(10) Pub. No.: US 2021/0101224 A1
(43) Pub. Date: Apr. 8, 2021

(54) Shape Memory Alloy Starter for a Plasma Cutting Torch or Welder

(71) Applicant: The ESAB Group Inc., Florence, SC (US)

(72) Inventor: Michael Nadler, Wilmot, NH (US)

(21) Appl. No.: 16/590,469

(22) Filed: Oct. 2, 2019

(51) Int. Cl. B23K 10/02; H05H 1/34; B23K 9/067; B23K 9/173

(52) U.S. Cl. CPC B23K 10/02; H05H 1/34; H05H 2001/3489; B23K 9/173; H05H 2001/3426; B23K 9/0671

(57) ABSTRACT

A plasma arc torch comprises an electrode, a tip, and a shape memory alloy (SMA) starter. The electrode and the tip that are aligned concentrically with a gap therebetween. The electrode is adapted for electrical connection to a cathodic side of a power supply and the tip is adapted for electrical connection to an anodic side of the power supply during piloting. The SMA starter comprises a SMA starter element disposed between the electrode and the tip and is configured deform when heated. A deformation of the SMA starter element draws a pilot arc that extends at least partially through the gap between the electrode and the tip.

### TECHNICAL FIELD

An embodiment of the invention relates to a starter comprising a shape memory alloy and a method for reducing pilot voltage to generate a pilot arc by applying pilot current to the shape memory alloy.

### BACKGROUND

Current techniques and methods for initiating an arc in a plasma torch are limited. Typical plasma torches include a tip and electrode that are configured to generate an electric arc between these two components under suitable conditions. One method involves sending a high voltage spike (e.g., 6 kV to 10+kV) to a torch that is sufficient to reach the breakdown voltage of air. This spike causes air between the tip and the electrode to become partially conductive, and initiates a high frequency pilot arc between the tip and the electrode. This method is often referred to as high frequency (HF) starting. Other methods involve moving an element to pull apart an electrode and a tip that are in contact with each other to stretch an arc between the tip and the electrode, and are generally referred to as contact starting. Finally, other approaches include a third element that sits between the tip and the electrode. When current is delivered to the third element, an arc forms between the third element and the tip or the electrode and the arc may be used to form a pilot arc. One example of this method is discussed in U.S. Pat. No. 9,288,887, which is hereby incorporated by reference in its entirety. In this example, the third element is stationary.

Unfortunately, each of these methods presents a drawback. HF starting can create unwanted electromagnetic interference (EMI). As EMI may interfere with nearby electronic devices, shielding and insulation are needed to protect surrounding electronic components.

For the moving element (contact starting) approach, a precisely machined cartridge or moving component is fabricated, such that the component is actuated by air pressure and returned to its “off” position via a spring. Since plasma cutters are designed to operate through a wide range of cut currents, each of which requires a specific airflow, multiple start cartridges may be needed to start a torch that stats with a contact starting method, with each cartridge being tuned to a specific current. Moreover, consumables/cartridges for different cutting operations are often sized or configured differently (e.g., different consumables may have airflow holes of different sizes) and, thus, different moving components are typically manufactured for different cutting/welding scenarios, which adds complexity to setup and manufacturing operations.

Finally, using a third element may create power supply challenges since the third element is often energized by a separate high-voltage circuit that provides power while also preventing voltage from flowing towards the power supply or other critical components. Accordingly, this type of circuitry incurs additional cost as compared to HF starting. Moreover, EMI shielding may still be needed when using a stationary third element.

All of these methods incur added complexity and spatial challenges (either through the need to house a circuit, house a cartridge, or shield for EMI). Further, moving elements that are created with precision machining/manufacturing techniques may stop working properly after exposure to harsh conditions proximate to a work area. Accordingly, there is a need for an improved starter.

### SUMMARY

It is an object of the present invention to provide an improved starter comprising a shape memory alloy (SMA) and method of using the improved starter. More particularly, it is an object of the present invention to provide an improved starter that mitigates, alleviates, or eliminates one or more of the above-identified drawbacks associated with typical arc starting methods.

According to an embodiment, a starter element formed from a SMA material is provided. The SMA starter element, interposed between a tip and an electrode, may deform from a rest position in which the SMA starter element is in contact with one of a tip or an electrode, towards the other of the tip and the electrode to direct an arc into a gas flow path formed between the tip and the electrode.

More particularly, the SMA starter element may contact the tip when in a rest position and may deform to a position in which it is in contact with the electrode, or the SMA starter element may contact the electrode when in a rest position and may deform to a position in which it is in contact with the tip. Alternatively, the SMA starter element may deform to an intermediate position, in which the contact starter element is not in contact with either the tip or the electrode, and an arc is present between the SMA starter element and one of the tip and the electrode. Regardless, once the SMA starter element moves, an arc drawn out by the SMA starter element may then be “blown off” the SMA starter element (e.g., by process gas) and into contact with the other of the electrode and the tip.

According to at least one embodiment, a plasma torch can be constructed in accordance with one or more embodiments of the present application and may include: an electrode and a tip that are aligned concentrically with a gap therebetween, the electrode adapted for electrical connection to a cathodic side of a power supply, and the tip adapted for electrical connection to an anodic side of the power supply during piloting; and a shape memory alloy (SMA) starter comprising a SMA starter element disposed between the electrode and the tip, wherein the SMA starter element is configured to deform when heated, and wherein a deformation of the SMA starter element draws a pilot arc that extends at least partially through the gap between the electrode and the tip.

In some of these embodiments, a gas distributor is disposed between the electrode and the tip. Additionally or alternatively, the SMA starter element may be in contact with the tip when in a rest state, and the deformation of the SMA starter element may cause the SMA starter element to move to a deformed state where the SMA starter element is spaced apart from the tip. In some instances, the SMA starter element contacts the electrode when in the deformed state. Alternatively, the SMA starter element may not contact with the tip nor the electrode when in the deformed state. Still further, in some embodiments, the SMA starter element is in contact with the electrode when in a rest state, and the deformation of the SMA starter element causes the SMA starter element to move to a deformed state where the SMA starter element is spaced apart from the electrode. Moreover, in some embodiments, the pilot arc is blown off the SMA starter element, through a plasma chamber, and exits an orifice to generate a plasma stream for cutting metal.

The SMA starter element may be formed from copper-aluminum-nickel, nickel-titanium, or other alloys of zinc, copper, gold, and iron. Additionally, the SMA starter element may be formed from materials exhibiting a one way shape memory effect, including: a first SMA starter layer extending longitudinally along a length of the SMA starter element; a second SMA starter layer extending longitudinally along the length of the SMA starter element; and a deformable material disposed between and connecting the first SMA starter layer and the second SMA starter layer. When constructed as such, the deformation is a first deformation in a first direction, applying a current to the first SMA starter layer causes the first deformation, and applying current to the second SMA starter layer causes a second deformation of the SMA starter element in a second direction opposite the first direction. Additionally or alternatively, the SMA starter element may be formed from a material exhibiting a two-way shape memory effect, and applying current to the SMA starter element in a first position causes the deformation to a second position and cooling of the SMA starter element causes a return to the first position.

According to another embodiment, a consumable cartridge may be constructed in accordance with one or more embodiments of the present application and may include: an electrode; a tip disposed concentrically within the electrode and spaced from the electrode by a gap; and a shape memory alloy (SMA) starter element disposed between the electrode and the tip, wherein the SMA starter element is configured to deform in response to heat and a deformation of the SMA starter element moves the SMA starter element away from the electrode or the tip so that a pilot arc is drawn out in the consumable cartridge.

In some embodiments, a gas distributor is disposed between the electrode and the tip, the gas distributor being configured to direct a flow of gas into the gap between the electrode and the tip. Additionally or alternatively, the consumable cartridge may be a unitary cartridge so that at least the electrode, the tip, and the SMA starter element are irremovably coupled together. In various embodiments, the SMA starter element may function or be formed in the manner described above in connection with the SMA starter element of torches construed in accordance with embodiments of the present application. For example, the SMA starter element may be formed from copper-aluminum-nickel, nickel-titanium, or other alloys of zinc, copper, gold, and iron and may be formed from materials exhibiting a one-way shape memory effect or a two way shape memory effect.

According to yet other embodiments, a method of initiating a pilot arc in a plasma arc torch's consumable cartridge may be derived in accordance with one or more embodiments of the present application and may include: providing a shape memory alloy (SMA) starter comprising a deformable SMA starter element in a gap between an electrode and a tip, the deformable SMA starter element being disposed in a first position where the deformable SMA starter element contacts the tip or the electrode prior to being deformed; and applying current to the deformable SMA starter element to cause the deformable SMA starter element to deform and moves out of the first position so that a pilot arc is drawn out in the gap between the electrode and the tip.

Embodiments mentioned in relation to a first aspect of the present techniques are largely compatible with the further aspects described herein. Other objectives, features, and advantages will appear from the following detailed disclosure, from the attached claims, as well as from the drawings and are achieved, in full or at least in part.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers, or steps.

### BRIEF DESCRIPTION OF THE DRAWINGS

FIG. 1 is a perspective view of a plasma-based cutting system including a gas supply, a power source, and a plasma arc torch that implements the techniques of the present disclosure in accordance with at least one example embodiment.

FIG. 2A is an enlarged view of a portion of a plasma arc torch constructed in accordance with at least one example embodiment.

FIG. 2B is an enlarged view of a portion of a plasma arc torch in which the plasma arc torch and a removable cartridge are separate, in accordance with at least one example embodiment.

FIG. 3 is a cross-sectional view of a portion of a plasma arc torch constructed in accordance with at least one example embodiment.

FIG. 4A is an illustration of a SMA starter element, in which the SMA material is a one way shape memory alloy, in accordance with at least one example embodiment.

FIG. 4B is another illustration of a SMA starter element, in which the SMA material is a two way shape memory material, in accordance with at least one example embodiment.

FIG. 4C is yet another illustration of a SMA starter element, in accordance with at least one example embodiment.

FIG. 5A is a simplified illustration of a contact starter in which the SMA element is in a rest position, in accordance with at least one example embodiment.

FIG. 5B is a simplified illustration of a contact starter in which the SMA element, upon exposure to current, shifts from a rest position in contact with the tip (as shown in FIG. 5A) to a first active position in contact with the electrode (to generate an arc), in accordance with at least one example embodiment.

FIG. 5C shows translocation of the arc from initiation at the SMA element/electrode (as shown in FIG. 5B), passage through the plasma chamber, followed by exit at an outer orifice, in accordance with at least one example embodiment.

FIG. 5D shows an alternative configuration of the SMA starter element moving from a rest position (as shown in FIG. 5A) to a position in which the SMA starter element does not contact the tip or the electrode, in accordance with at least one example embodiment.

The skilled person realizes that a number of modifications of the embodiments described herein are possible without departing from the present techniques. The above, as well as additional objects, features and advantages of the present techniques, will be better understood through the following illustrative and non-limiting detailed description of embodiments of the present techniques, with reference to the appended drawings, where the same reference numerals may be used for similar elements.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. In an embodiment, pilot current flows through a SMA starter element, and the internal resistance of the SMA starter element causes the starter element to heat and deform. As the starter element deforms away from the surface to which it is in contact (e.g., a tip or electrode), an arc is drawn between the SMA starter element and the surface. For example, the arc may sweep/bridge the entire gap between a tip and an electrode and, thus, may reduce the pilot voltage needed to start the plasma torch. Once the arc has been generated, the arc may be blown off the SMA starter element, e.g., by plasma gas flowing towards the plasma chamber. The arc, which is positioned in the plasma gas flow path, may pass through the plasma chamber to exit the outer orifice, producing a jet of plasma for cutting operations.

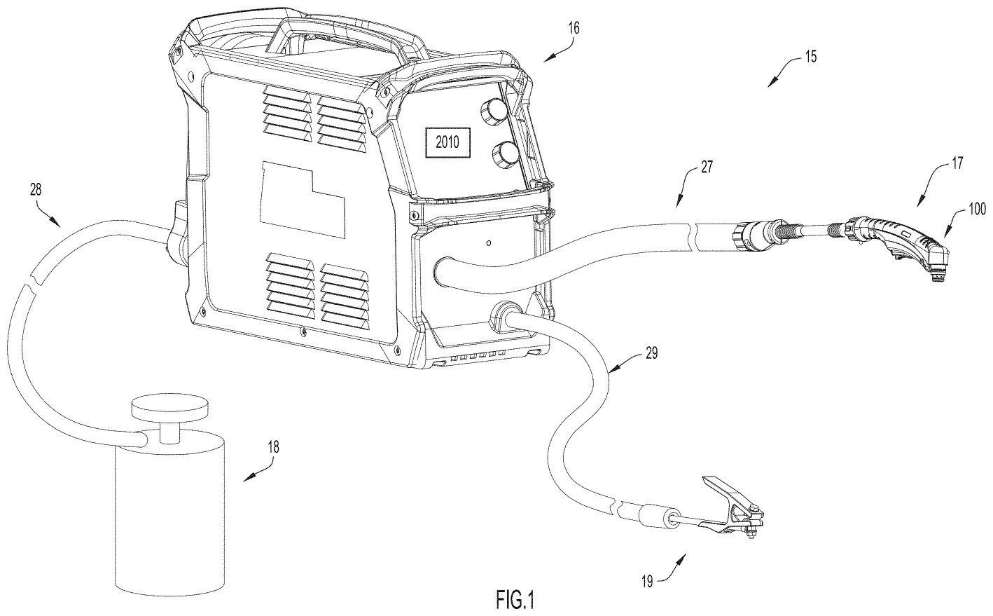

FIG. 1 illustrates an example embodiment of a cutting system 15 that may utilize the techniques presented herein. This cutting system is only depicted as an example of a cutting or welding system that may implement the techniques presented herein and the techniques presented herein can be implemented in any welding or cutting system that requires an arc for starting. In this example, the depicted cutting system 15 includes a main power supply/source 16 that supplies power to a torch assembly 17 (including a plasma arc torch 100). The main power supply 16 also controls the flow of gas from a gas supply 18 to the torch assembly 17 (however, in other embodiments, the main power supply 16 might supply the gas itself). The gas supply 18 may be connected to the power supply via cable hose 28 and the main power supply 16 may be connected to the plasma arc torch 100 included in the torch assembly 17 via cable hose 27. The cutting system 15 also includes a working lead 29 with a grounding clamp 19. Additionally, the main power supply 16 may include or be operatively connected to a secondary power supply 2010 that may supply a suitable amount of current to deform a SMA starter element included in the plasma arc torch 100. Secondary power supply 2010 may be integrated into main power supply 16 or may be a stand-alone separate power supply.

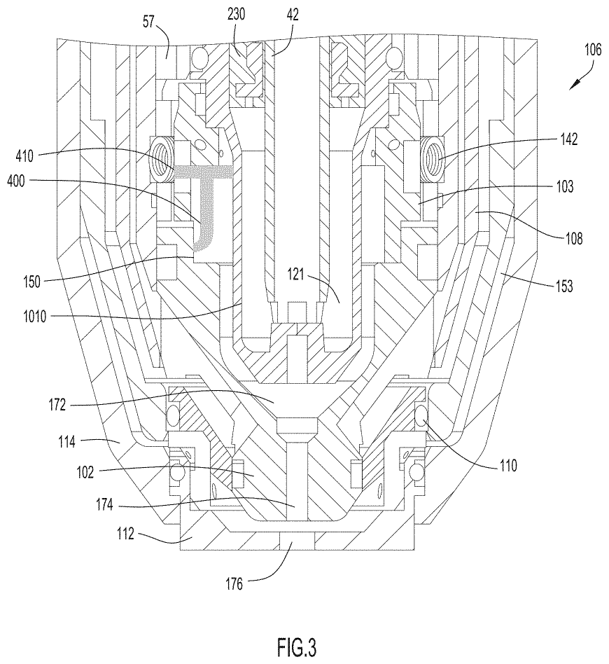

Generally, and now referring to FIG. 1 in combination with FIG. 3, when operating in accordance with the techniques presented herein, the power source may supply current to the SMA starter element 400 through a SMA contact 410 (see, FIG. 3). In some cases, the path from the power source to the SMA starter element may include components to modulate, raise or lower the current supplied to the SMA starter element. In other cases, the SMA starter element may utilize its own stand-alone power supply. In still other aspects, the power source may supply current to the SMA starter element 400 via a conductive component 142 (see, FIG. 3) without the SMA contact. In FIG. 3, conductive component 142, surrounds the outer surface of distal anode member 108 and may also connect to the SMA contact 410 (or in other aspects, directly to SMA starter element 400) to supply current to the SMA starter element 400 from the power supply. However, many different configuration are possible, and the examples provided herein are not intended to be limiting.

Now turning back to FIG. 1, cable hose 27, cable hose 28, and/or cable hose 29 may each include various conductors so that the cable hoses can transmit data, electricity, signals, etc. between components of the cutting system 15 (e.g., between the main power supply 16 and the plasma arc torch 100 of the torch assembly 17). As illustrated, cable hose 27, cable hose 28, and/or cable hose 29 may each be any suitable length. In order to connect the aforementioned components of cutting system 15, the opposing ends of cable hose 27, cable hose 28, and/or cable hose 29 may each be coupled to the main power supply 16, plasma arc torch 100, gas supply 18, or clamp 19 in any manner now known or developed hereafter (e.g., a releasable connection). For example, the plasma arc torch 100 may be releasably coupled to the main power supply 16 via a releasable connection formed between the cable hose 27 and the main power supply 16 and/or via a releasable connection formed between the cable hose 27 and the plasma arc torch 100.

As described herein, a plasma torch or plasma arc torch may be understood by one of skill in the art to be an apparatus that generates or uses plasma for operations such as cutting, welding, etc., and may be operated in a manual, automated, or hybrid fashion. Specific references to plasma arc torches or to the deformable starter should not be construed as limiting the scope of the present techniques. These techniques may be used with any suitable apparatus in which a deformable starter element may be used to initiate an arc. Additionally, specific references to plasma gas should not be construed to limit the scope of the present techniques in that other fluids or gases, e.g., liquids or air, may be provided to the plasma arc torch in accordance with the techniques provided herein.

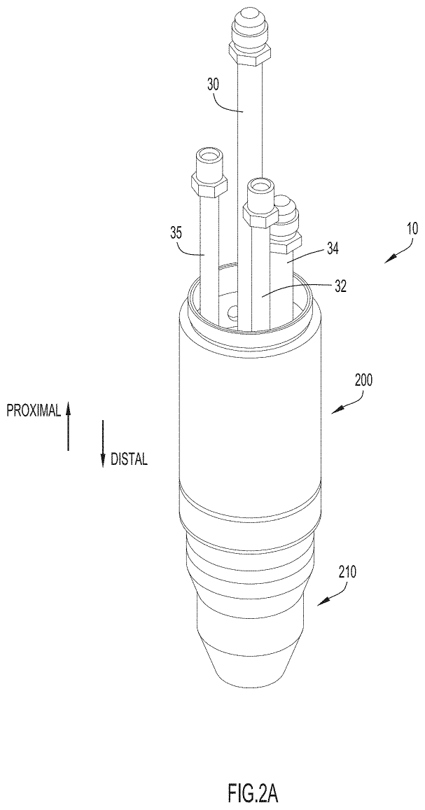

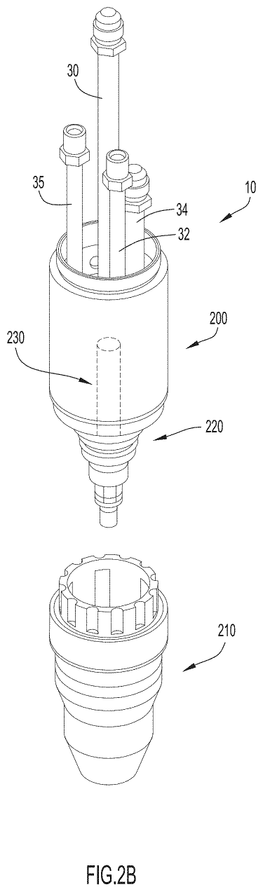

Referring to FIG. 2A, an operative end 10 of a plasma arc torch is shown. The operative end 10 of the plasma arc torch may comprise a plurality of consumable components 210 secured to plasma torch base 200 of the operating end of the plasma arc torch. In this embodiment, the SMA starter element is contained in the plurality of consumable components 210, which is replaceable. However, in other embodiments, the SMA starter may be included in the torch (e.g., torch head) and may be suitable for use with a wide variety of interchangeable consumables. Regardless, the SMA starter element is suitable for both automated and manual plasma arc torches. While the examples provided herein are largely shown in the context of SMA starter elements embedded in consumable cartridges, these examples are intended to be non-limiting, and also apply to systems without a replaceable cartridge (e.g., systems with consumables that are replaceable individually).

In the embodiment shown in FIG. 2A, the plasma arc torch includes or is adjoined with a coolant supply tube 30, a plasma gas tube 32, a coolant return tube 34, and a secondary gas tube 35 so that plasma gas and secondary gas can be supplied to and cooling fluid can be supplied to and returned from the operative end 10 of the plasma arc torch during cutting operations. In general, the proximal direction refers to a direction extending towards the plasma torch base 200 from the consumable components 210, and the distal direction refers to a direction extending towards the consumable components 210 from the plasma torch base 200.

FIG. 2B shows plasma torch base 200 detached from consumable components 210. As can be seen, the plasma torch base 200 includes an anode body 220 that is in electrical communication with the positive terminal of the main power supply 16, and an element 230 that is in electrical communication with the a cathode, a negative terminal of the power supply (see FIG. 1). The plasma torch base 200 may further include one or more insulators (not shown) to insulate the cathode from the anode body.

FIG. 3 shows a detailed example of plasma head 106, which corresponds to a distal portion of an operative end 10 of a plasma arc torch. One or more of the components shown here may reside in consumable components 210, which may be enclosed in a cartridge or provided as individual components.

A wide variety of plasma torches and consumable structures for the same are known in the art. At least one example plasma torch is discussed in detail in U.S. Pat. No. 9,288,887, which is incorporated by reference in its entirety (as mentioned above). However, in general, a plasma torch (e.g., a manual torch or automated torch) comprises a tip, an electrode, a plasma chamber, and an outer orifice from which a plasma stream exits the plasma torch. Each of these components will be described in additional detail below, along with other exemplary components. These examples are not intended to be limiting. Additionally, plasma torches may comprise various layers of insulation for insulating internal components (e.g., the anode, cathode, etc.), and may comprise various tubing for distributing coolant gas, plasma gas, and secondary gas along with other components, as described in the art. For brevity, at least some of these components are not described in detail herein, but the lack of description is not intended to imply that these components are or should be omitted from a plasma torch implementing the techniques presented herein.

That said, in FIG. 3, the coolant tube 42 may define a cylindrical tube in fluid communication with coolant supply tube 30. Generally, the coolant tube 42 serves to distribute cooling fluid through the plasma head 106. Additionally, consumable components 210, which connect to the plasma torch base 200 may comprise an electrode 1010, a tip 102, a gas distributor 103, a SMA starter element 400, a SMA contact 410, and a cartridge body (part of consumable components 210), which houses and positions various components for distributing plasma gas, secondary gas, and cooling fluid during operation of the plasma arc torch 100. The SMA starter element may be housed in the cartridge body as described in further detail below.

Additionally, consumable components 210 may comprise a distal anode member 108 and a central anode member (not shown) that can be coupled to the anodic side of the power supply and provide electrical continuity to tip 102. In particular, the distal anode member 108 is disposed next to a baffle member 110 and is in electrical contact with the tip 102 at a distal portion of the plasma head 106. The baffle member 110 is disposed between the distal anode member 108 and a shield cap 114. Further, consumable components 210 may comprise a secondary cap 112 defining an outer orifice 176. A locking mechanism (not shown) may secure the consumable components 210 to plasma torch base 200.

The electrode 1010 is centrally disposed within the cartridge body and is in electrical contact with element 230. Distal passageways 121 may be in fluid communication with the coolant tube 42 to provide cooling to the plasma chamber and surrounding regions. The tip 102 is electrically separated from the electrode 1010 so that a gap is formed between the elongate sides of these two elements and a plasma chamber 172 is formed between a bottom of the electrode 1010 and a bottom of the tip 102. The tip 102 further comprises an orifice 174, through which a plasma stream exits during operation of the plasma arc torch as the plasma gas is ionized within the plasma chamber 172.

The shield cap 114 generally secures and positions the consumable components therein, in addition to insulating an area surrounding the torch from the conductive components during operation. The shield cap 114 is preferably made of a non-conductive, heat insulating material, such as a phenolic or ceramic. In this particular embodiment, secondary gas flows from a plurality of proximal axial passageways 57 formed in the cartridge body into a secondary gas passage 153 and through the secondary cap 112, to shield and/or stabilize the plasma stream exiting the secondary cap 112 when the torch is in operation.

Still referring to FIG. 3, but now with reference to FIG. 1, when electric power is applied to the plasma arc torch 100, a voltage is applied across the electrode 1010 and the tip 102 by the main power circuit from main power supply 16. In particular, cathodic or negative potential is carried by the element 230 and the electrode 1010 while anodic or positive potential is carried by anode body 220, the distal anode member 108, a central anode that connects the anode body 220 to the distal anode member 108, and the tip 102. Additionally, to implement the techniques presented herein, current is applied to the SMA starter element 400. In some embodiments, main power circuit from main power supply 16 delivers current to the SMA starter element 400. Additionally or alternatively, the secondary power supply 2010 and may be in electrical communication with the SMA starter element 400.

When the gas supply is activated, a gas flows through the plasma gas tube 32 and is vented into the gas-receiving chamber 150. Current is applied to the SMA starter element 400 via SMA contact 410 and/or via the tip 102. As the SMA starter element 400 heats up (due to the current causing resistive heating) and deforms away from the tip, a pilot arc is drawn between the SMA starter element 400 and the tip 102. However, in other embodiments, the SMA starter element 400 could initially receive current from electrode 1010 and could draw a pilot arc between the SMA starter element 400 and the electrode 1010. Put another way, generally, as the SMA starter element deforms, a pilot arc is generated between the tip or electrode and SMA starter element due to the voltage difference.

Regardless of the specific deformation that generates the pilot arc, plasma gas flowing past the arc may force the arc down along the gas-receiving chamber 150 between the gas distributor 103 and the electrode 1010 into the plasma chamber 172 between the electrode 1010 and the tip 102. That is, the SMA starter element 400 may draw out an arc that may be blown off the SMA starter element into the plasma chamber 172. As the arc reaches the orifice, the arc is pushed out of the tip 102 to a gap between the tip 102 and the secondary cap 112. Secondary gas flows into the gap to stabilize the plasma stream exiting the orifice 174 of the tip 102. As a result, a highly uniform and stable plasma stream exits the outer orifice 176 of the secondary cap 112 for high current, high tolerance cutting operations.

Present techniques allow for a pilot arc to be generated between the SMA starter element and the corresponding surface that the SMA starter element deformed away at a lower voltage potential as compared to techniques provided in the art. Thus, in some embodiments, the secondary power supply 2010 may comprise a low power circuit, contained within main power supply 16, which may fire automatically whenever an open circuit voltage is present or may be triggered by a signal to fire. In other aspects, the low power circuit may be contained in a stand-alone unit near plasma arc torch 100 to provide a current to the SMA starter element. The low power circuit may be automatically energized when an open circuit voltage is detected in the power supply, or may be remotely controlled, for example, by a signal from a controller (not shown). Thus, in some cases, a dedicated secondary power supply 2010 may be provided to generate the current supplied to the SMA starter element 400, which may be integrated into main power supply 16 or be a stand-alone unit. In still other cases, the current may be supplied directly by main power supply 16.

Generally, shape memory alloys may include any material that deforms when heated, and upon cooling, returns to its pre-deformed position (i.e., a deformed state). Such behavior may be modeled using hysteresis curves, which may map material states of the SMA as a function of temperature. Types of deformable materials suitable for SMA starter elements include but are not limited to copper-aluminum-nickel (Cu—Al—Ni), nickel-titanium (Ni—Ti), or other alloys of zinc, copper, gold, and iron. Still other types of shape memory alloy materials include Fe—Mn—Si and Cu—Zn—Al.

Moreover, alloy materials for the SMA starter element 400 may be selected to be compatible with the internal environment of the torch. In some embodiments, temperatures for plasma torch streams may exceed 20,000° C., and in some aspects, may be greater than 28,000° C. Accordingly, the operative end 10 of the plasma arc torch may become heated due to proximity to the cutting plasma stream. To select a suitable SMA material as well as determine placement of the SMA starter element 400, thermal models may be constructed to simulate the temperature distribution of the plasma arc torch (or at least the operative end 10). In some cases, the total deformation of the SMA starter element 400 may be a combination of the internal environment of the plasma arc torch (which may be heated due to proximity to the plasma torch) as well as heat generated from the application of pilot current to the SMA starter element 400.

In some aspects, the position of the SMA starter element 400 within the operative end 10 of a plasma arc torch may be determined based upon a simulated or a measured temperature distribution within the plasma arc torch (or at least within the operative end 10). Accordingly, material for the SMA starter element 400 and placement of the SMA starter element may be selected so that operation remains within the boundaries of a material hysteresis curve, so to prevent thermal breakdown and irreversible deformation of the SMA starter element.

In some aspects, the SMA starter element 400 may be selected to have material properties suitable for operation in high temperature environments. In other aspects, the plasma arc torch may be modified to control the temperature of the environment into which the SMA starter element 400 is placed (e.g., by isolating the SMA starter element from high temperatures via insulation layers, proximity to coolant gas, physical placement within a minimum distance of the external orifice, etc.). During operation, the SMA starter element 400 is exposed to a suitable temperature for deformation and is not exposed to conditions that cause thermal breakdown of the material, leading to irreversible deformation. The SMA starter element 400 may be placed in any suitable position in the operative end 10 of the plasma arc torch, provided that the SMA starter element 400 contacts plasma gas, and is able to generate an arc to travel through a plasma chamber 172 to ignite the pilot arc for the plasma torch.

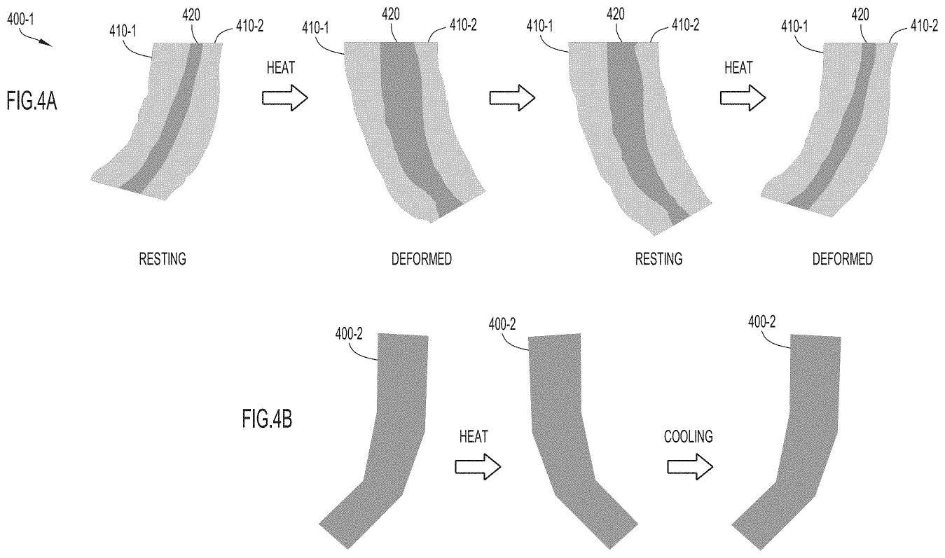

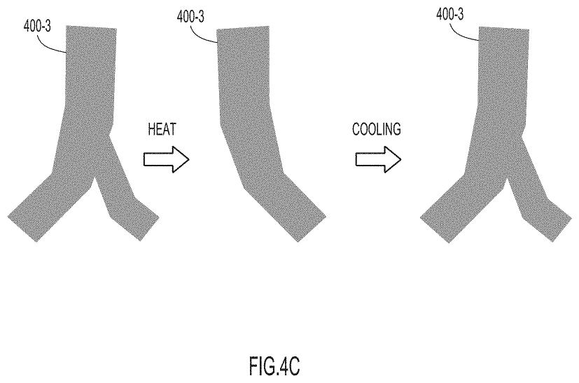

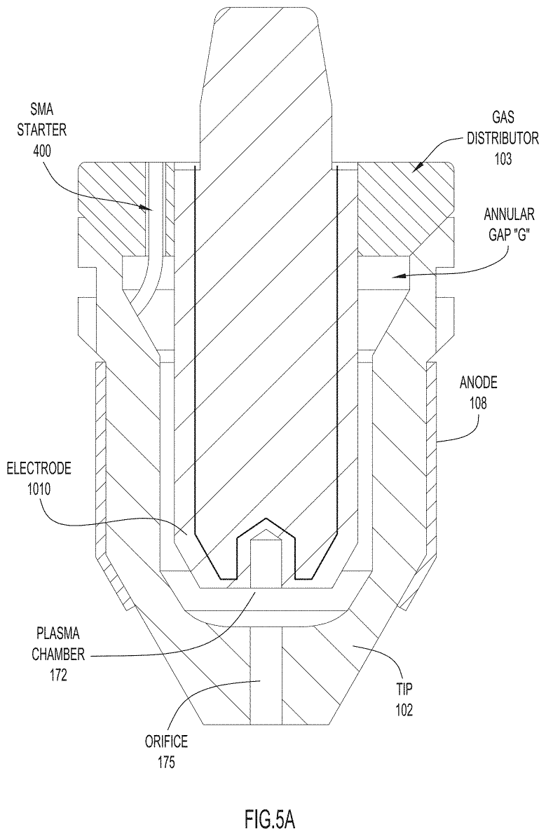

FIGS. 4A, 4B, and 4C show example designs of the SMA starter element 400. These examples are intended to be non-limiting and, in various embodiments, any suitable shape or geometry may be employed for the SMA starter element.

In general, the SMA starter element 400 will toggle between two different conformations. As shown in FIG. 4A, for materials exhibiting a one way shape memory effect, two opposing SMA layers or SMA wires 410-1 and 410-2, both extending longitudinally along a length of the SMA starter element, may be contained within the SMA starter element 400-1, joined by a flexible and heat resistant material 420. For example, in some embodiments, the SMA starter element may comprise a first SMA layer/wire 410-1 and a second SMA layer/wire 410-2, such that each wire is programmed to attain a specific shape when heated. Current may be applied independently and sequentially to each wire to toggle the configuration of the starter element between a resting and deformed configuration (i.e., a deformed state).

For example, in one embodiment, the first SMA wire 410-1 may be programmed to attain a first configuration when heated, and the second SMA wire 410-2 may be programmed to attain a second configuration when heated. Since one-way shape memory materials do not typically return to their original shape upon cooling, materials may be positioned to directionally oppose each other, and current may be applied sequentially to each wire to toggle between SMA starter element 400-1 configurations.

Moving from left to right in FIG. 4A, initially, the first SMA wire 410-1 is in a first configuration and the second wire is in an elongated phase (the first resting stage). When current is applied to the second SMA wire 410-2, the second wire deforms to a second configuration, causing elongation of the first SMA wire 410-1 (the first deformed stage or state). After deforming the second SMA wire 410-2, current to both wires can be turned off and the SMA starter element 400-1 will remain in its current position (the second resting stage). Then, when current may then be applied to the first SMA wire 410-1 (without supplying current to the second wire), causing the first wire to return to a first configuration and the second wire to become elongated. This process may repeat during subsequent starting operations.

For materials having a two-way shape memory effect, as shown in FIG. 4B, the SMA starter element 400-2 may contain a single wire. The wire may be trained, using thermomechanical treatments known in the art, to attain a first specific shape when heated and a second specific shape when cooled. For example, in one embodiment, the wire may be programmed to have a specific configuration (e.g., a rest position or configuration) when cooled and to attain another configuration (e.g., a deformed position, configuration, or state) when heated. In this case, the SMA starter element 400-2 returns to its original conformation upon cooling, as is depicted in FIG. 4B. This process may repeat during subsequent starting operations.

FIG. 4C illustrates yet another embodiment of a SMA starter element 400-3. In this embodiment, the wire is bifurcated (e.g., split or Y-shaped) and consolidates into a linear shape as it is heated. The heated shape can be straight or arcuate despite FIG. 4C illustrating an arcuate heated shape and can correspond to a position that is in contact with one of an electrode and a tip. Alternatively, in some embodiments, a bifurcated SMA starter element 400-3 may move in an opposite manner to the movement illustrated in FIG. 4C. That is, a bifurcated SMA starter element 400-3 can move from a linear shape to a bifurcated shape as it is heated. Still further, in some embodiments, both branches of the bifurcated SMA starter element 400-3 can move in response to resistive heating so that, for example, the SMA starter element 400-3 moves from a Y-shape to a straight, linear shape as it is heated. To facilitate the aforementioned movements, each branch of the bifurcated SMA starter element 400-3 can be manufactured in any desirable manner. For example, each branch can formed from two materials exhibiting a one-way shape memory effect (like in FIG. 4A), one material exhibiting a two way shape memory effect (like in FIG. 4B), or some combination thereof.

Moreover, although not shown, any of the embodiments illustrated in FIGS. 4A-4C may have additional branches. These branches may provide redundant points of contact that attempt to ensure the SMA starter element can draw out and/or transfer an arc. For example, each branch of SMA starter element 400-3 could be bifurcated (so that SMA starter element 400-3 has four branches or legs) to provide two points of contact with both a tip and an electrode when the SMA starter element 400-3 is in a cooled configuration/conformation. Similarly, SMA starter element 400-1 or 400-2 could be split any number of times to provide two or more points of contact with a consumable component and/or two or more points for drawing out an arc. In fact, in some embodiments, the SMA starter element can be annular and provide redundant points of contact spaced around its entire circumference. Alternatively, a plasma torch or plasma torch consumable might include separate SMA starter elements spaced radially around a particular central location to provide such redundancy (e.g., spaced at every 60 or 90 degrees). That is, a plasma torch might include an array of SMA starter elements and one or more of the SMA starter elements in the array might be split (e.g., bifurcated) to provide additional contact redundancy.

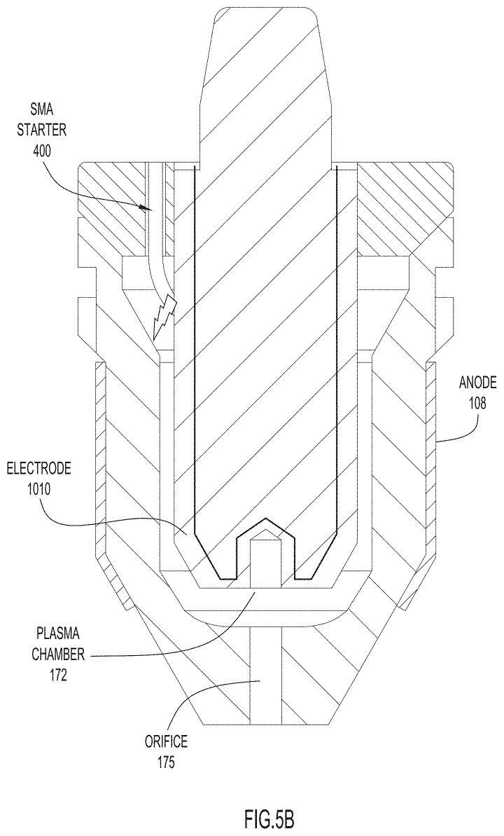

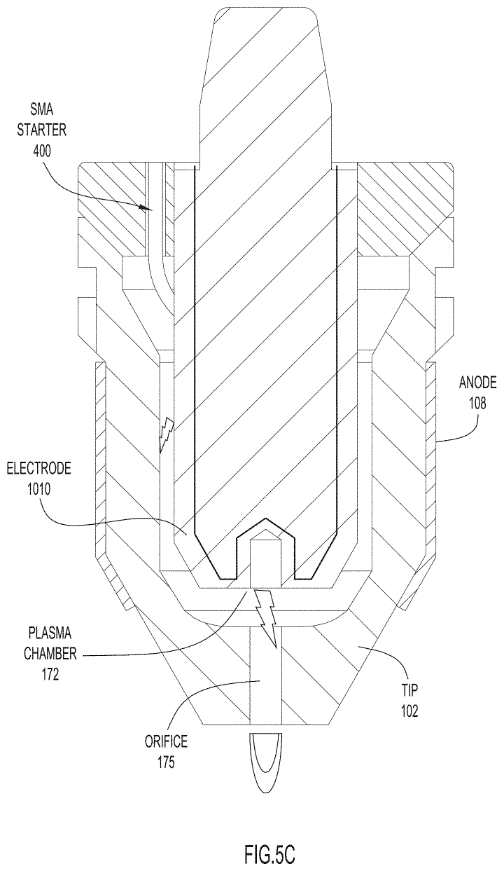

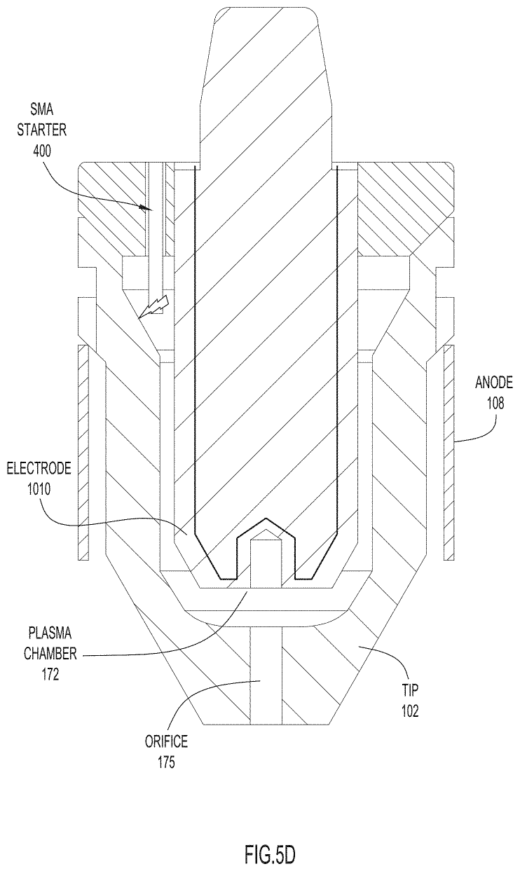

FIGS. 5A-5D show additional embodiments of positioning the SMA starter element 400 in the operative end 10 of a plasma arc torch (i.e., in or adjacent consumables). These illustrations are simplified to show a tip 102, an electrode 1010, a gas distributor 103 and the SMA starter 400. Notably, the SMA starter element is largely disposed in an annular gap “G” between the tip 102 and the electrode 1010. In this particular embodiment, the SMA starter 400 is positioned in the gap by the gas distributor 103. For example, a proximal end of the SMA starter 400 may be secured or embedded in the gas distributor 103 in a position that aligns at least a proximal end of the SMA starter 400 with the gap G (the distal end may, in at least some states, be contacting the tip 102 or electrode 1010, which define boundaries of gap G). However, as mentioned, in some embodiments, more than one SMA starter 400 may be secured in gap G (e.g., spaced radially around gap G at every 60 or 90 degrees). In fact, in some instances, it is possible that movement of a single SMA starter element 400 within gap G may cause gas flowing through the consumables to flow asymmetrically, but an array of SMA starter elements 400 may rebalance the flow (e.g., provide symmetrical flow).

The gas distributor 103 may also serve to insulate the electrode 1010 from the tip 102 (and vice versa) and may securely position the electrode 1010 concentrically within the tip 102. In fact, in at least some embodiments, the tip 102, the electrode 1010, the gas distributor 103, and the SMA starter 400 may form a unitary cartridge. That is, these components may be irremovably coupled together. Thus, when one of the components reaches an end of life state, the cartridge may be replaced as a whole and none of the individual components may be replaceable individually. Thus, the SMA starter 400 may be inaccessible to a user, which may prevent the user from damaging or otherwise moving the SMA starter 400 in a manner that negatively effecting piloting operations (i.e., arc generation operations) of the SMA starter 400.

Still referring to FIGS. 5A-5D, when pilot current is delivered to the plasma arc torch, the pilot current is delivered to the tip 102. In at least some embodiments, this pilot current may flow from the tip 102 into the SMA starter element 400 (since the SMA starter element 400 is in direct contact with the tip 102 and both parts are conductive) and the resistance of the SMA material may cause the SMA starter element 400 to heat and deform. As it deforms, the SMA starter element 400 moves out of contact with the tip 102 to draw an arc away from the tip 102. In some instances, the arc is drawn until it sweeps/bridges the gap G between the tip 102 and the electrode 1010. Alternatively, the arc can be drawn until it bridges a portion of the gap G.

However, the SMA starter element 400 need not always be actuated/deformed with a constant pilot current. In fact, in some instances, the actuation (e.g., deformation) of the SMA starter element 400 may be more precisely controlled with current ramping techniques that might provide fine-tuned control of SMA starter element deformation. In some instances, the current delivered to the SMA starter element may be based on ramping techniques typically used during arc initiation. Alternatively, current delivered to the SMA starter element may be ramped independently of any ramping techniques typically used during arc initiation. Regardless, ramping the current delivered to the SMA starter element may, in some instances, cause a quicker deformation of the SMA starter element which, in turn, may cause the SMA starter element to quickly move between heated and cooled positions. Reducing the deformation time may also decrease the time that the arc is on the SMA starter element which may prolong the life of the SMA starter element. This may be particularly beneficial since the SMA starter element may be formed from a material that has a reduced arc life as compared to the materials used to form a tip or electrode (e.g., copper).

As an example or current ramping, in some embodiments, the SMA starter element 400 might be preheated with 20 Amps of current for a predetermined amount of time and then the current can be dropped to 10A until a deformation occurs. Alternatively, after the preheating, the current could be slowly reduced. These ramping operations may serve to decrease the deformation time (e.g., reduce the time between pilot start and deformation) without destroying the “memory” of the SMA starter element 400 by overheating the SMA starter element 400 (the reduction in current may prevent this overheating). Additionally or alternatively, in some embodiments, the current could be pulsed with pulse width modulation (PWM) techniques and the duty cycle could be controlled over time to control/reduce opening time without destroying the “memory” of the SMA starter element 400. For example, the current might be delivered with 100% duty cycle for a predetermined amount of time and then ramped down prior to a deformation.

Regardless of how the defamation is caused or controlled, once an arc is drawn out, it can be blown off the SMA starter element 400 and move into contact with the tip 102 and electrode 1010. The arc travels through the plasma chamber to exit the orifice 175. FIGS. 5A-5D show example embodiments of the SMA starter element (circled) in additional detail. However, this is only one embodiment and in other embodiments, an arc might be drawn in an opposite direction, from the electrode 1010 to or towards the tip 102. In these embodiments, the SMA starter 400 may be initially positioned in contact with the electrode 1010 (i.e., its rest state might be curved towards electrode 1010 instead of curved towards tip 102 as shown in FIGS. 5A-5D) and deform towards the tip 102.

FIG. 5A shows a SMA starter element 400 configured to generate an arc between the tip 102 and the electrode 1010. The proximal end of the SMA starter element 400 is in contact with a current source, and the distal end of the SMA starter element 400 extends into contact with the tip 102. The SMA starter element 400 may move within a passageway bounded by the tip 102 and electrode 1010. As current flows through the SMA starter element 400, the material heats up and deforms the starter element away from the tip 102, causing the S MA starter element to lose contact with the tip 102 and move towards the electrode 1010.

As the SMA starter element 400 is drawn away from the tip 102, an arc forms between the SMA starter element 400 and the tip 102, as shown in FIG. 5B. The SMA starter element 400 may contact the electrode 1010, drawing an arc from the tip 102 to the electrode 1010. Once the arc is formed, the arc may be blown off the starter, as shown in FIG. 5C, and translocate to the plasma chamber 172 before creating a cutting arc that can exit the orifice 175. In some embodiments, the arc may mix with the secondary gas from secondary gas tube 35, which stabilizes the plasma stream, prior to or subsequent to exiting the orifice 175. The pilot arc then exits the plasma arc torch, also shown in FIG. 5C, to form a plasma cutting stream, e.g., for cutting metal. However, secondary gas is not necessary and some embodiments may generate a stream of plasma without a secondary gas.

FIG. 5D shows another embodiment of a SMA starter element 400 that forms a pilot arc. In this embodiment, the starting position of the SMA starter element 400 is in contact with the tip 102, as shown in FIG. 5A. However, as current is applied to the SMA starter element 400, the SMA starter element 400 deforms to a deformed position (i.e., a deformed state) in which the SMA starter element 400 is disposed between the tip 102 and the electrode 1010, but is not in contact with either the electrode 1010 or the tip 102. In this configuration, the arc may span from the tip 102 to the SMA starter element 400, and may be blown off the SMA starter element 400 and into contact with the electrode 1010. Once the arc spans the tip 102 and electrode 1010, the arc will move into the plasma chamber 172 and exits the orifice 175, like the previously discussed embodiments.

That is, in the embodiment depicted in FIG. 5D, it may be optional or unnecessary for the SMA starter element 400 to progress from the first deformed position to a second deformed position (e.g., being in contact with the tip or electrode). Instead, it may be sufficient for the pilot arc to span from the tip or electrode to the SMA starter element (rather than the entire width between the tip and electrode).

The SMA starter element presented herein has several advantages over traditional methods as it does not require complex additional circuitry, special shielding (as HF starting techniques), or precise machining of movable parts for specific cutting scenarios. Instead, the SMA starter element is positioned to receive pilot current, and its deformation draws out an arc within the plasma chamber. Moreover, the SMA starter element does not need to be changed for specific cutting scenarios.

It should be noted that the disclosure is not limited to the embodiments described and illustrated as examples. A large variety of modifications has been described and more are part of the knowledge of the person skilled in the art. These and further modifications as well as any replacement by technical equivalents may be added to the description and figures, without leaving the scope of the protection of the disclosure and of the present patent.

What is claimed is:

1. A plasma arc torch comprising:
an electrode and a tip that are aligned concentrically with a gap therebetween, the electrode adapted for electrical connection to a cathodic side of a power supply, and the tip adapted for electrical connection to an anodic side of the power supply during piloting; and
a shape memory alloy (SMA) starter comprising a SMA starter element disposed between the electrode and the tip, wherein the SMA starter element is configured to deform when heated, and wherein a deformation of the SMA starter element draws a pilot arc that extends at least partially through the gap between the electrode and the tip.

2. The plasma arc torch according to claim 1, further comprising a gas distributor disposed between the electrode and the tip.

3. The plasma arc torch according to claim 1, wherein the SMA starter element is in contact with the tip when in a rest state, and the deformation of the SMA starter element causes the SMA starter element to move to a deformed state where the SMA starter element is spaced apart from the tip.

4. The plasma arc torch according to claim 3, wherein the SMA starter element contacts the electrode when in the deformed state.

5. The plasma arc torch according to claim 3, wherein the SMA starter element is not in contact with the tip and is not in contact with the electrode when in the deformed state.

6. The plasma arc torch according to claim 1, wherein the SMA starter element is in contact with the electrode when in a rest state, and the deformation of the SMA starter element causes the SMA starter element to move to a deformed state where the SMA starter element is spaced apart from the electrode.

7. The plasma arc torch according to claim 1, wherein the pilot arc is blown off the SMA starter element, through a plasma chamber, and exits an orifice to generate a plasma stream for cutting metal.

8. The plasma arc torch according to claim 1, wherein the SMA starter element is formed from copper-aluminum-nickel, nickel-titanium, or other alloys of zinc, copper, gold, and iron.

9. The plasma arc torch according to claim 1, wherein the SMA starter element is formed from materials exhibiting a one way shape memory effect, and comprises:
a first SMA starter layer extending longitudinally along a length of the SMA starter element;
a second SMA starter layer extending longitudinally along the length of the SMA starter element; and
a deformable material disposed between and connecting the first SMA starter layer and the second SMA starter layer,
wherein the deformation is a first deformation in a first direction, applying a current to the first SMA starter layer causes the first deformation, and applying current to the second SMA starter layer causes a second deformation of the SMA starter element in a second direction opposite the first direction.

10. The plasma arc torch according to claim 1, wherein the SMA starter element is formed from a material exhibiting a two-way shape memory effect, and applying current to the SMA starter element in a first position causes the deformation to a second position and cooling of the SMA starter element causes a return to the first position.

11. A consumable cartridge comprising:
an electrode;
a tip disposed concentrically within the electrode and spaced from the electrode by a gap; and
a shape memory alloy (SMA) starter element disposed between the electrode and the tip, wherein the SMA starter element is configured to deform in response to heat and a deformation of the SMA starter element moves the SMA starter element away from the electrode or the tip so that a pilot arc is drawn out in the consumable cartridge.

12. The consumable cartridge according to claim 11, further comprising a gas distributor disposed between the electrode and the tip, the gas distributor being configured to direct a flow of gas into the gap between the electrode and the tip.

13. The consumable cartridge of claim 11, wherein the consumable cartridge is a unitary cartridge so that the electrode, the tip, and the SMA starter element are irremovably coupled together.

14. The consumable cartridge according to claim 11, wherein the SMA starter element is in contact with the tip when in a rest state, and the deformation of the SMA starter element causes the SMA starter element to move to a deformed state where the SMA starter element is spaced apart from the tip.

15. The consumable cartridge according to claim 14, wherein the SMA starter element contacts the electrode when in the deformed state.

16. The consumable cartridge according to claim 14, wherein the deformed SMA starter element is not in contact with the tip and is not in contact with the electrode when in the deformed state.

17. The consumable cartridge according to claim 11, wherein the SMA starter element is in contact with the electrode when in a rest state, and the deformation of the SMA starter element causes the SMA starter element to move to a deformed state where the SMA starter element is spaced apart from the electrode.

18. The consumable cartridge according to claim 11, wherein the SMA starter element is formed from copper-aluminum-nickel, nickel-titanium, or other alloys of zinc, copper, gold, and iron.

19. The consumable cartridge according to claim 11, wherein the SMA starter is formed from materials exhibiting a one-way shape memory effect or a two way shape memory effect.

20. A method of initiating a pilot arc in a plasma arc torch comprising:
providing a shape memory alloy (SMA) starter comprising a deformable SMA starter element in a gap between an electrode and a tip, the deformable SMA starter element being disposed in a first position where the deformable SMA starter element contacts the tip or the electrode prior to being deformed; and
applying current to the deformable SMA starter element to cause the deformable SMA starter element to deform and moves out of the first position so that a pilot arc is drawn out in the gap between the electrode and the tip.
